(19) United States
(12) Patent Application Publication
(10) Pub. No.: US 2026/0122453 A1
(43) Pub. Date: Apr. 30, 2026

(54) ONE WAY SPORTS WIRELESS COMMUNICATION DEVICE AND METHOD AND NON VERBAL COMANDS FOR TRAINING PURPOSES

(71) Applicant: Digiwrist Technology, Inc., Las Vegas, NV (US)

(72) Inventors: Milton Powell, Buda, TX (US); Romano Russo, Oro Valley, AZ (US); Danny McLane, Santa Clara, CA (US); Gerhard de Beer, Tucson, AZ (US)

(21) Appl. No.: 18/933,760

(22) Filed: Oct. 31, 2024

(51) Int. Cl. H04W 4/12; A63B 71/06; H04B 1/08; A63B 102/18

(52) U.S. Cl. CPC H04W 4/12; A63B 71/0622; H04B 1/086; A63B 2071/0663; A63B 2102/18; A63B 2102/182; A63B 2225/50

(57) ABSTRACT

The disclosure relates to a sports communication system for communication between members of a team, e.g., players and coaches of a sports team during a sports competition, that includes a wireless computer device in wireless communication with a receiver worn by a team member wherein the wireless computer device comprises: a display, a transmitter module, a microcontroller, a power supply, and an antenna. The receiver worn by the team member includes an antenna, a modulator, a microcontroller, a power supply, and a display, and the wireless communication is one-way communication from the wireless computer device to the receiver that does not even include a handshake from the receiver to the wireless computer device, and the communication between the wireless computer device and the receiver includes text messaging.

### BACKGROUND

### TECHNICAL FIELD OF THE INVENTION

The technical field of the invention is communication devices used in sporting competitions as well as Government, Hospitality, Retail, Industrial, and Aviation.

### DESCRIPTION OF THE RELATED ART

There is a need to enhance the participation in sports for the deaf and hard of hearing athletes around the world. Thus, making it feasible for kids with a mental disability like Borderline Intellectual Functioning to understand the complexity of the play calling. Also, to provide a system for kids of all ages to use and easily understand the sports language. Further, to remove sign stealing from sports that utilize hand signals through wireless play calling and shorten game time by increasing the speed of play. Also, for nonverbal commands and communication for government, retail, hospitality, industrial, and aviation field training and professional purposes.

### SUMMARY DISCLOSURE OF THE INVENTION

The disclosure relates to a sports communication system for communication between members of a team, e.g., players and coaches of a sports team during a sports competition, that includes a wireless computer device in wireless communication with a receiver worn by a team member wherein the wireless computer device comprises: a display, a transmitter module, a microcontroller, a power supply, and an antenna. The receiver worn by the team member includes an antenna, a modulator, a microcontroller, a power supply, and a display, and the wireless communication is one-way communication from the wireless computer device to the receiver that does not even include a handshake (2 way confirmation done automatically) from the receiver to the wireless computer device, and the communication between the wireless computer device and the receiver includes text messaging. The receivers have the ability to manually confirm receipt of the initial commands to and from the tablet.

This disclosed device will improve training efficiency, and ensure that players, staff and trainees receive instructions without needing to leave their positions or halt the flow of a game. It will solve time delays or signal stealing from the opponent. It will allow coaches to quickly adapt their strategies and communicate changes to players in real time. The disclosed systems and methods will help especially in fast-paced sports where rapid decisions are required. This system will eliminate verbal instructions, confusing hand signals, complex card reading or time-consuming face-to-face interactions. This leads to no more miscommunication, delays or inefficiencies.

Other features and aspects will be apparent from the following detailed description, the drawings, and the claims.

### BRIEF DESCRIPTION OF THE DRAWINGS

FIG. 1 shows a receiver of the disclosure.

FIG. 2 shows a wireless computer device of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DISCLOSURE OF THE INVENTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

### MODES FOR CARRYING OUT THE INVENTION

In embodiments, the invention is directed to one-way communication devices, and methods of using, designed for transmitting information from a sender to a receiver without enabling feedback. The device includes a transmitter module, a repeater, power supply, a detachable dongle with an exterior folding or retractable antenna, and a user interface. It can be used in applications where unidirectional communication is required.

In one embodiment, the system can include a wireless computer device and one or more receivers. The computer may have an interior or exterior detachable dongle with an exterior folding or retractable antenna. The computer can be a tablet computer, notebook or laptop computer, desktop computer, or mobile computing device, or the like. The receiver can be configured to be worn by a player, in a sporting context, or Government, Hospitality, Retail, Industrial, and Aviation industries. The receiver can have a display and may be configured to be worn on the wrist of a user.(player, staff, trainee, professional)

The present invention thus relates to communication devices, e.g., to one-way communication devices designed for transmitting information, for example, play calls in the sports setting from a sender to a receiver without the capability of automatic feedback or response from the receiver of any form, in embodiments, not even a “handshake” back to the interface. With exception of a manual response from the user.

The components include a transmitter module, a microcontroller, memory storage, a modulator, and antenna, a power supply, a user interface, a display screen, and typically a button or switch.

The Transmitter Module is a core component responsible for sending the signal. It includes a microcontroller, memory storage, a modulator, an antenna, power supply, and a user interface which can include a display and a button or switch.

A Microcontroller manages the device's operations. Memory Storage stores pre-recorded messages or real-time information to be transmitted. A Modulator converts the information into a transmittable signal. An antenna radiates the signal into the air. A power supply provides the necessary power to the transmitter module. It can be a battery or a connection to an external power source. A user interface allows the sender to control the device, which may include a button or switch to start and stop a transmission. The display screen can show the status of a transmission.

System operation can include message preparation, transmission activation, signal modulation, signal transmission, signal reception, message interpretation, and power management.

The user records or selects a message to be transmitted, which is stored in the memory of the computer. The message can be a text message. The computer can be a portable laptop or notebook computer, or a desktop, or a mobile device including a smart phone or tablet. The user can activate the device, for example, by using a button or switch on the user interface or by voice activation. The microcontroller retrieves the message from memory and sends it to the modulator. The modulated signal is sent to an antenna, which broadcasts it to the receiver(s).

The receivers receive the signal at an antenna. A Modulator receives the message and sends it to a microcontroller in the receiver. The Modulator sends the message to the receiver’s micro controller which then interprets the message, can vibrate upon reception, and displays it to the player on a display, such as a TFT display or the like. In embodiments, the device includes a power management system to ensure efficient use of power, which can turn off the transmitter when not in use to conserve battery life.

In embodiments, the system includes a detachable dongle which is detachable from the interface/transmitting computer, the exterior of which can have an exposed folding or retractable antenna on the casing.

The wrist receiver can pair to the interface using Bluetooth or a QR code. In embodiments, the wrist receiver can be approximately 2.5” to 3” long. An associated tablet or computer can send a text message to the wrist receiver worn by a player(s) in a sports context. The signal can be transmitted using RF, Bluetooth, LoRa WAN, or an in stadium network. In embodiments, no handshake is required for the wrist receiver to acknowledge receipt of transmission. In embodiments, the system does not use cellular or 5G but has the capability of connecting to those networks. The wrist receiver can have an LED screen.

Voice to text message interpretation can be used to transmit to the wrist receivers using LoRa WAN or ISM915 Radio Frequency, or in stadium network. In embodiments, the wrist receiver can include a wrist sleeve which is approximately 4,7” long with 2” neoprene padding on a flap and around the edges of the receiver for additional protection. An accelerometer can enable motion detection and enhances user interaction. Edge Computing can be used to process data locally, reducing the need for cloud-based processing and improving response times. Long-Range Communication can utilize both LoRa and RF 915MHz for extended communication range, capable of transmitting through in stadium networks.

The receiver can be about 2.5 to about 3 inches long and can vary in size from plus or minus about 2.5 inches. The receiver can be of a smartwatch design. Enclosures that house the computer and receiver’s electronic components can vary for physical appearance and size. Communication protocols can be either known or specially designed for a particular application. Different methods of activating the transmission can be used such as verbal activation.

Wrist cloths are custom made to fit only the receiver and are specifically padded around the edges and the flap with neoprene padding for impact purposes. PCB can be used for the transmitter and for the receiver.

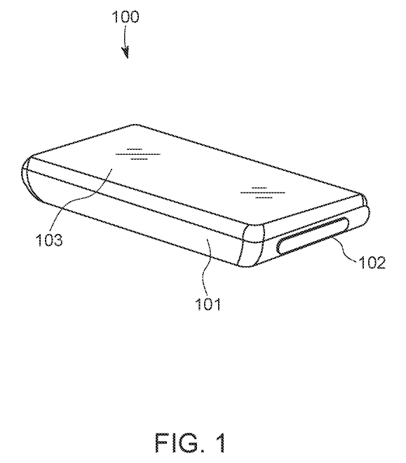

FIG. 1 shows a receiver 100 of the disclosure. Receiver body 101 includes a microcontroller and modulator (not shown). FIG. 1 also shows antenna 102 and display 103.

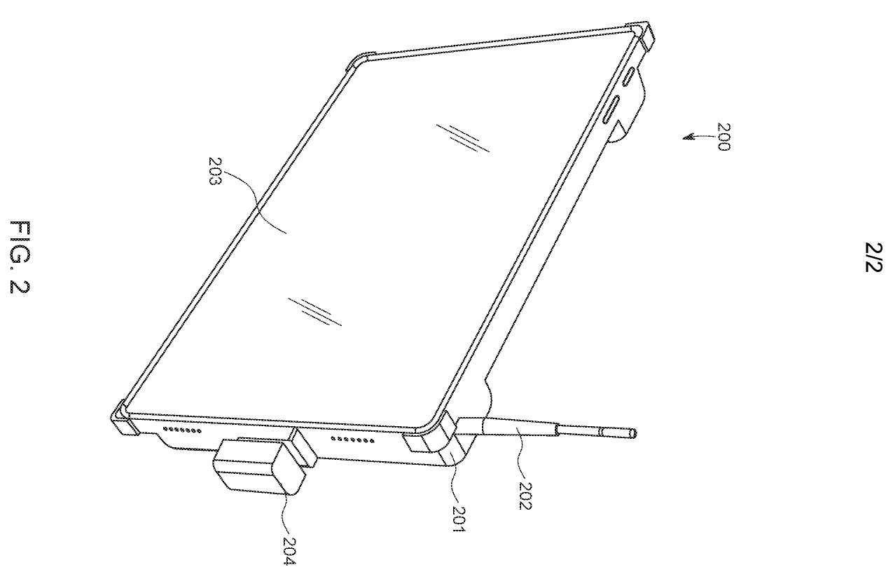

FIG. 2 shows of wireless computer device 200 of the disclosure. FIG. 2 shows wireless computer device body 201 which includes transmitter module, a microcontroller, memory storage, a modulator, and a power supply (not shown). FIG. 2 also shows wireless computer device antenna 202, wireless computer device screen 203, and detachable dongle 204.

In embodiments, the disclosure includes sports, and professional communication products and systems which include a wireless computer device and wireless communication with a receiver. More specifically, the wireless communication between the wireless computer device and the receiver is one way communication. The receiver may be worn by a player in the sports competition, preferably, on the wrist of the player. Preferably, the wireless communication includes text messaging. In one specific embodiment, the system can be used to communicate plays from a coach to a player in a sporting match or competition.

In embodiments, the disclosure also includes methods of using a sports communication system, as disclosed herein, in a sporting competition that includes inputting messages into a wireless computer device, transmitting the messages to a receiver worn by a player in a sporting competition, wherein the messages can be text messages, receiving the messages at the receive, and displaying the messages. The receiver receives the messages from the wireless computer device and displays them to the player. The communication can be one-way communication between the wireless computer device and the receiver worn by the player. In a preferred embodiment, the wireless computer device can be operated by a coach, or player not active in the competition, and the receiver can be worn by the player during the competition.

### GLOSSARY

A wireless computer device of the disclosure generally refers to tablet computers, portable laptop or notebook computers, desktop computers, as well as smart phones. The wireless computer device generally includes a display, a transmitter module, memory, a microcontroller, and an antenna.

A transmitter is an electronic device which produces electromagnetic waves, typically radio waves, with an antenna and with the purpose of signal transmission to a receiver. The transmitter generates a radio frequency alternating current, which is applied to the antenna. When excited by this alternating current, the antenna radiates radio waves. See Transmitter, Wikipedia, the free encyclopedia, of record, herein incorporated by reference.

A repeater is an electronic device that receives a signal and then retransmits it. Repeaters can be used to extend transmissions so that the signal can cover longer distances or be received on the other side of an obstruction. See Repeater, Wikipedia, the free encyclopedia, of record, herein incorporated by reference.

The receiver or receiver device of the disclosure generally refers to a device between about 1 and about 3 inches wide and about 1 and about 3 inches long. The receiver preferably includes a display, an antenna, a modulator, a microcontroller, and a power supply. The receiver can be configured to be worn on the wrist of a player in a sporting competition, game, match, or contest. The receiver can be rectangular or square in shape. The receiver can be of a smartwatch design. The receiver can have a display capable of displaying text messages. The display could be a TFT display or other active matrix display.

The term “team” generally is used in its normal sense to mean a plurality of persons associated together in work or an activity. Preferably, the activity is a sports activity or sports competition or game. Baseball or softball is a preferred game.

The term “competition” is used in its normal sense and refers to a type of contest between teams or a match or trial between teams. The competition preferably is a sports competition.

The term “sports” generally refers to team sports or athletic competition including baseball, softball, football, hockey, basketball, volleyball, and the like. Any team sporting competition is contemplated. For example, the communication system could generally provide communication between and amongst players and coaches. In a preferred embodiment, the sports communication system can be football, baseball or softball and includes communication between a coach or manager and all participants and non-participants in the field of play. In a preferred embodiment, the communication can be with or between a coach, catcher, or pitcher or other player for the purpose of play calling.

In other embodiments, the receiver may be worn by professional staff, government, or federal trainees.

One-way wireless communication means that the wireless communication between the computer device and the receiver is one way originating from the computer device to the receiver with no possibility of any wireless communication originating from the receiver device to the computer device, i.e., not even a handshake communication.

A handshake is a signal between two computer devices or programs used to authenticate or coordinate the devices. A handshake is normally accomplished before any further communication between the devices can occur. Handshaking can negotiate parameters that are acceptable to computer devices at both ends of a communication, including but not limited to, information transfer rate, coding alphabet, parity, interrupt procedure, and other protocol or hardware features. Accordingly, lack of a return handshake from a receiver device to a transmitter device means that no communication can occur originating from the receiver device to the transmitter device. See Handshake, Wikipedia, the free encyclopedia, of record, herein incorporated by reference.

Text message communication as referred to herein generally refers to composing and sending electronic messages, typically consisting of alphabetic and numeric characters, between two or more users of mobile phones, tablet computers, smartwatches, desktops/laptops, or other types of compatible computer devices. Preferably SMS type text messaging and other forms of text messaging that include displaying text are contemplated. See Text Messaging, Wikipedia, the free encyclopedia, of record, herein incorporated by reference.

A microcontroller as used herein refers to a small computer on a single integrated circuit. A microcontroller generally includes one or more CPUs (processor cores) along with memory and programmable input/output peripherals. See Microcontroller, Wikipedia, the free encyclopedia, of record, herein incorporated by reference.

A dongle or detachable dongle refers to an exterior or interior computer hardware component that can connect to an interior or exterior port to provide it with added functionality, in embodiments, in this case an antenna. See Dongle, Wikipedia, the free encyclopedia, of record, herein incorporated by reference.

Wireless communication generally includes Long Range Wide Area Network (LoRa ) and Radio Frequency (RF), including RF 915MHz for extended communication range, capable of transmitting through, in house or in stadium networks (e.g., a wireless in stadium private network), sports networks, etc., Local Area Networks (LAN), Bluetooth, Wi-Fi, 3G, 4G, 5G, 6G, and the like. See LoRa, Wikipedia, the free encyclopedia, of record, herein incorporated by reference.

A local area network (LAN) is a computer network that interconnects computers within a specific area such as a residence, school, laboratory, university campus or office building. Preferably, the local area network could be an in stadium network or a sports network. See Local Area Network, Wikipedia, the free encyclopedia, of record, herein incorporated by reference.

While this disclosure includes specific examples, it will be apparent after an understanding of the disclosure of this application has been attained that various changes in form and details may be made in these examples without departing from the spirit and scope of the claims and their equivalents.

1. A communication system for communication between members of a team during a competition comprising:
a wireless computer device in wireless communication with a receiver device worn by a member of a team during the competition, wherein the wireless computer device comprises: a display, a transmitter module, a microcontroller, a power supply, and an antenna;
the receiver device worn by another member of the team comprising: an antenna, a modulator, a microcontroller, a power supply, and a display;
wherein the wireless communication is one-way wireless communication from the wireless computer device to the receiver device, wherein the one way wireless communication does not include any wireless communication originating from the receiver device to the wireless computer device; and
wherein the communication between the wireless computer device and the receiver comprises text messaging.

2. The sports communication system of claim 1, wherein the communication between the wireless computer device and the receiver device consists of text messaging.

3. The sports communication system of claim 1, wherein the receiver worn by the player is worn on a wrist of the player.

4. The sports communication system of claim 1, wherein the receiver display is a TFT display.

5. The sports communication system of claim 1, wherein the receiver is about 1 inches to about 5 inches long and about 1 inches to about 5 inches wide.

6. The sports communication device of claim 1, wherein the receiver is about 2.5 inches to about 3 inches long and about 2.5 inches to about 3 inches wide.

7. The sports communication system of claim 1, wherein the wireless computer device is a tablet computer.

8. The sports communication system of claim 1, wherein the wireless computer device further includes a detachable exterior or interior dongle comprising an antenna.

9. The sports communication system of claim 1, wherein the communication is via Radio Frequency (RF), Bluetooth, 4G, 5G, 6G, or Long Range Wide Area Network (LoRa WAN).

10. The sports communication system of claim 1, wherein the wireless computer device is in wireless communication with a Local Area Network.

11. The sports communication system of claim 1, wherein the competition is baseball or softball.
